(19) United States
(12) Patent Application Publication
(10) Pub. No.: US 2017/0004112 A1
(43) Pub. Date: Jan. 5, 2017

(54) DETECTING OPERATIONAL VARIANCES AND DETERMINING VARIANCE INTENSITIES

(71) Applicant: CA, Inc., New York, NY (US)

(72) Inventors: Venkata Naresh Chippada, Cupertino, CA (US); David Brooke Martin, San Jose, CA (US); Sai Krishna Kanth Rayanapati, Foster City, CA (US); Prasanna Ram Venkatachalam, Fremont, CA (US); Vijay S. Desai, San Diego, CA (US)

(21) Appl. No.: 14/788,558

(22) Filed: Jun. 30, 2015

(51) Int. Cl. G06F 17/18

(52) U.S. Cl. CPC G06F 17/18

(57) ABSTRACT

A measurement associated with a component being monitored is received. An operational variance of the component is detected based, at least in part, on the measurement. A variance intensity associated with the operational variance is determined and a variance intensity threshold associated with the variance intensity is determined.

### BACKGROUND

The disclosure generally relates to the field of computing systems, and more particularly to determining variance intensities.

Performance monitoring systems monitor various aspects of complex computing systems, including various hardware and software components. A performance monitoring system may receive a variety of data from many different data sources. For example, the performance monitoring system may receive performance measurements, error notifications, status messages, etc. The data sources can be hardware, such as a network device, or software, such as an application or module within an application. The data collected by the performance monitoring system can be used to identify potential issues that might arise during the operation of the monitored computing system.

### BRIEF DESCRIPTION OF THE DRAWINGS

Embodiments of the disclosures herein may be better understood by referencing the accompanying drawings.

FIG. 1 depicts an example system that includes a performance manager that detects operational variations and determines associated variance intensities.

FIG. 2 depicts a flowchart of example operations for detecting an operational variance.

FIG. 3 depicts a flowchart of example operations for determining a variance intensity.

FIG. 4 depicts a flowchart of example operations for updating a window of time intervals.

FIG. 5 depicts a flowchart of example operations for determining variance intensity thresholds.

FIG. 6 depicts a flowchart of example operations for determining a scaled variance intensity based, at least in part, on one or more functions.

FIG. 7 depicts an example computer system with a performance manager.

### DESCRIPTION

The description that follows includes example systems, methods, techniques, and program flows that embody aspects of the disclosures herein. However, it is understood that this disclosure may be practiced without these specific details. For instance, this disclosure refers to monitoring the performance of computing system components in illustrative examples. But aspects of this disclosure can be applied to other types of monitoring, such as error monitoring, signal monitoring, etc. In other instances, well-known instruction instances, protocols, structures and techniques have not been shown in detail in order not to obfuscate the description.

Statistical process control is a technique for monitoring and controlling processes using statistical methods. Aspects of statistical process control can be applied to computing systems and related areas. For example, statistical control charting can be used to monitor the stability of a signal transmitted over a wire or the performance of a software module on a server. Statistical control charting generally involves a series of measurements of the system being monitored (although statistical control charting can be adapted to scenarios in which multiple measurements occur at the same time). The series of past measurements are used to determine a normal operating range of the system. The normal operating range can be defined by one or more rules that indicate when the operation of the system falls outside of the normal operating range (hereinafter “operational variance”). For example, a rule might specify that an operational variance occurs when a measurement associated with the system being monitored exceeds a particular threshold or when a set of measurements meet one or more criteria.

As mentioned above, statistical control charting can be used to monitor the performance of a computing system. In particular, a performance manager monitors the operation of a system component, such as a server or application. While monitoring the operation of the component, the performance manager detects operational variances by determining whether aspects of the component's operation breach one or more rules. If a rule is breached, the performance manager determines a “variance intensity,” which describes the magnitude of the operational variance. To determine the variance intensity, the performance manager identifies weights associated with each of the breached rules. One or more of the weights are added to a history of weights associated with previously breached rules. The performance manager determines the variance intensity based, at least in part, on the history of weights. The performance manager can determine variance intensity thresholds associated with the variance intensity based, at least in part, on the configuration of the performance manager and/or computing system. Additionally, the performance manager can scale the variance intensity to generate a scaled variance intensity.

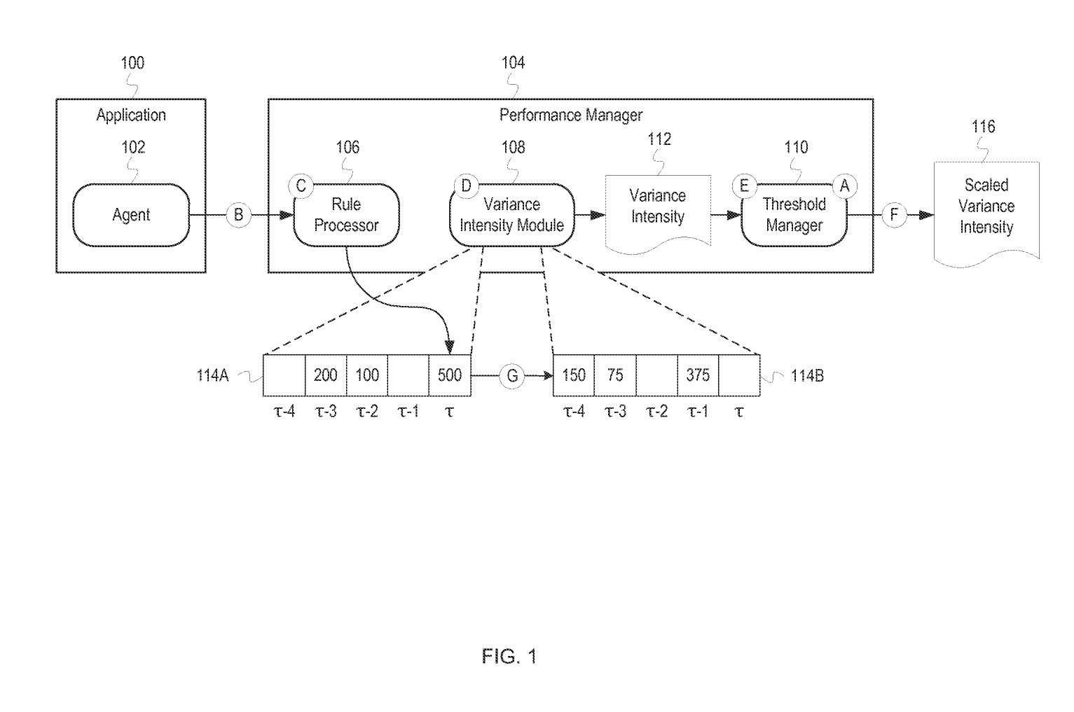

FIG. 1 depicts an example system that includes a performance manager that detects operational variations and determines associated variance intensities. FIG. 1 depicts an application 100 and a performance manager 104. The application 100 includes an agent 102 and the performance manager 104 includes a rule processor 106, variance intensity module 108, and threshold manager 110. The variance intensity module 108 determines and outputs a variance intensity 112 and the threshold manager 110 determines and outputs a scaled variance intensity 116.

In this example, the performance manager 104 monitors the response latency (hereinafter “latency”) of the application 100. The response latency is the amount of time between when the application 100 receives a request and when the application 100 sends a response to the request. The agent 102 performs the actual measurement of the response latency and sends the measurements to the performance manager 104.

As described above, the performance manager 104 maintains a history of weights associated with breached rules. The history comprises a set of time intervals referred to as a “window”. In FIG. 1, the history is depicted as the window 114A, which comprises five time intervals, τ-4 through τ. After each time interval, the window 114A is updated by shifting the values in the window 114A one time interval to the left. Thus, the value associated with time interval τ becomes associated with τ-1 and the value associated with τ-4 is dropped, similar to a first-in-first-out queue. In this example, the performance manager 104 implements the window 114A as an array. Each element of the array corresponds to a time interval. However, the implementation of the window 114A can vary. For example, the performance manager 104 can use a circular buffer, linked list, or other data structure.

Various aspects of the operation of the performance manager 104 can be configurable. For example, the duration of the time intervals, the size of the window 114A (i.e., number of time intervals that comprise the window 114A), and weights associated with rules can be configurable. Prior to the performance manager 104 beginning monitoring of the application 100, the performance manager 104 can determine the current configuration by accessing configuration data (not depicted). The performance manager 104 can read the configuration data from a data source, such as a database or file system. Some or all of the configuration data can be embedded in the performance manager 104 (e.g., hard coded). The description below assumes that any configurable values have been determined (e.g., loaded from configuration data) prior to use of the configurable values.

FIG. 1 also depicts a set of stages, A through G, which illustrate the operation of the various components of FIG. 1 and are described below. Stage A describes the determination of one or more variance intensity threshold values. Typically, the operations performed at stage A are performed once (e.g., prior to the first use of the variance intensity thresholds) while the operations performed at stages B through G are performed multiple times (e.g., each time a measurement is received). However, the operations performed at stage A may be performed multiple times. For example, if one or more of the configurable values changes, the threshold manager 110 might perform the operations of stage A to determine updated variance intensity threshold.

At stage A, the threshold manager 110 determines one or more variance intensity thresholds in accordance with the current configuration of the performance manager 104. In particular, the threshold manager 110 determines the size of the window 114A, the average of the weights of the rules used to detect operational variances, and one or more current threshold levels. The size of the window 114A is the number of time intervals that comprise the window 114A. In this example, the size of the window 114A is five.

As mentioned above, the performance manager 104 uses one or more rules to detect operational variances (discussed in more detail below). Each rule is assigned a weight. To determine the average of the weights, the performance manager 106 sums the weights assigned to the rules and divides the sum by the number of rules. For example, if the weights associated with the rules are 500, 300, 200, and 100, the average is 275.

The current threshold levels are values used by the threshold manager 110 to scale the variance intensity thresholds. For example, the threshold manager 110 may be implemented to determine a first and a second variance intensity threshold (e.g., a “caution” and a “danger” threshold). Both the first and the second variance intensity threshold can have corresponding current threshold levels. The current threshold levels can conform to a predetermined or configurable scale. For example, the current threshold levels might be represented by a value between 1 and 5, inclusive. The threshold manager 110 can read the window size, the rule weights, and the current threshold levels from configuration data.

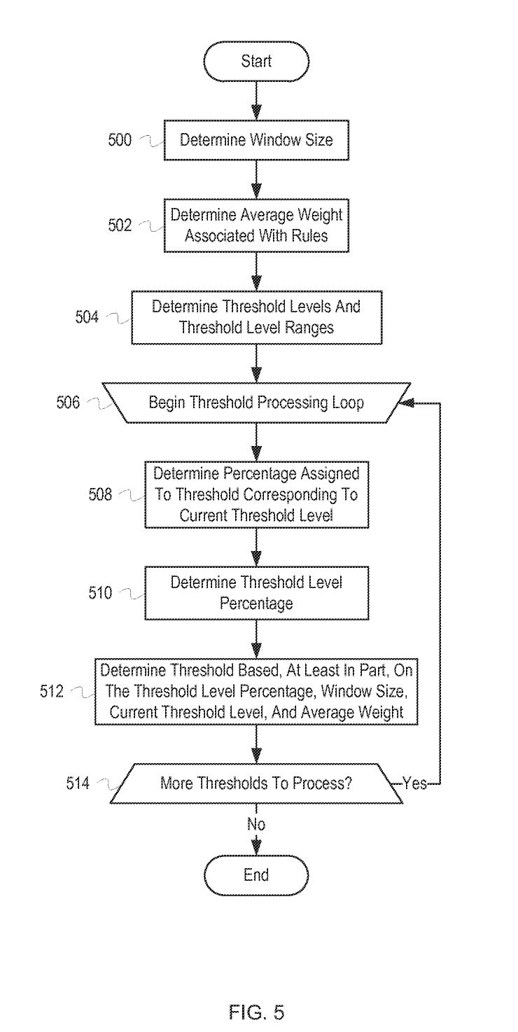

Once the threshold manager 110 determines the window size, the average rule weight, and the current threshold levels, the threshold manager 110 determines the variance intensity thresholds. In particular, for each current threshold level, the threshold manager 110 determines a variance intensity threshold based, at least in part, on the window size, the average rule weight, and the current threshold level. The particular technique used to determine the variance intensity threshold can vary; some techniques may produce variance intensity thresholds that more closely reflect the issues encountered in various scenarios. An example of a technique for determining the variance intensity thresholds is described below in relation to FIG. 5.

At stage B, the agent 102 sends a latency measurement to the performance manager 104. Although depicted as a module embedded in the application 100, the agent 102 can be any entity that sends measurements to the performance manager 104. For example, the agent 102 can be the application 100 itself or a separate application that facilitates the monitoring of the application 100. The agent 102 can send latency measurements to the performance manager 104 on a periodic basis, in response to a request from the performance manager 104, etc. Once received, the performance manager 104 performs operations associated with receiving the latency measurement, including providing the latency measurement to the rule processor 106.

At stage C, the rule processor 106 detects an operational variance associated with the application's latency. To determine the operational variance associated with the application's latency, the rule processor 106 determines whether the latency measurement results in one or more rules being breached. The particular mechanism used to evaluate the rules can vary. For example, some rules might be breached when a measurement exceeds a threshold. To determine whether such a rule is breached, the rule processor 106 can determine whether the latency measurement received at stage A exceeds the associated threshold. As another example, some rules might be breached when a set of measurements meet a particular criteria. For example, a rule might be breached when two out of three measurements (e.g., the latency measurement received at stage A and two previously received latency measurements) exceed a threshold. To determine whether such a rule is breached, the rule processor 106 can maintain and analyze a history of received latency measurements or track characteristics of the received latency measurements.

If the latency measurement results in one or more rules being breached, the rule processor 106 identifies a weight associated with each of the breached rules. The weights can be stored as part of the configuration data described above. The particular values used for the weights can vary. For example, the weights might be a set of integers within a certain range, decimal values between zero and one, etc. Once the weights of the breached rules are determined, the rule processor 106 associates the greatest of the weights with the current time interval, τ. For example, if the weights of the breached rules are 200, 300, and 500, the rule processor 106 inserts the value “500” into the array representing the window 114A. In particular, “500” is inserted into the element corresponding to τ, as illustrated in FIG. 1.

If the latency measurement does not result in one or more rules being breached, the rule processor 106 does not associate a weight with current time interval. In some instances, however, the rule processor 106 does associate a value with the current time interval. For example, the rule processor 106 might associate a null value, a zero, etc. with the current time interval when no rules are breached.

At stage D, the variance intensity module 108 determines the variance intensity 112. To determine the variance intensity 112, the variance intensity module 108 sums the values in the window 114A. In this example, the variance intensity 112 is 800. Once determined, the variance intensity module 108 sends the variance intensity 112 to the threshold manager 110.

At stage E, the threshold manager 110 scales the variance intensity 112 to generate the scaled variance intensity 116. In particular, the threshold manager 110 scales the variance intensity 112 in accordance with a variance intensity scale. By scaling the variance intensity 112 in accordance with the variance intensity scale, the scaled variance intensity 116 will be within the range defined by the variance intensity scale regardless of the particular variance intensity and/or variance intensity thresholds. In other words, the scaling of the variance intensity 112 allows the sensitivity of the performance manager 104 to be adjusted while outputting values within a static range.

The particular technique used by the threshold manager 110 to scale the variance intensity 112 can vary. Generally, the threshold manager 110 scales the variance intensity 112 by mapping the variance intensity 112 to the variance intensity scale. However, the variance intensity 112 can be mapped to the variance intensity scale by utilizing a variety of techniques such as applying a scaling factor, mapping a scale based on the variance intensity thresholds and weights to the variance intensity scale, applying one or more functions, etc. Examples of particular techniques that the threshold manager 110 may use are described below.

At stage F, the threshold manager 110 outputs the scaled variance intensity 116. The threshold manager 110 can output the scaled variance intensity 116 to the performance manager 104 or another component, such as a management user interface (not depicted). The threshold manager 110 may store the scaled variance intensity 116 for later use.

At stage G, the variance intensity module 108 updates the window 114A to reflect the passing of a time interval. As described above, the window 114A is implemented using an array in this example. Thus, to update the window 114A, the variance intensity module 108 shifts the individual time intervals. In particular, the value associated with time interval τ-4 is overwritten by the value associated with time interval τ-3; the value associated with time interval τ-3 is overwritten by the value associated with time interval τ-2, etc.

When updating the window 114A, the variance intensity module 108 can apply a decay factor. The decay factor decreases the impact of older breached rules. To apply the decay factor, the variance intensity module 108 reduces the value stored in a particular time interval before shifting the value to the new time interval. Thus, if the decay factor is 0.5 and the value stored in τ is 500, the variance intensity module 108 overwrites the value in τ-1 with the value 250 (500×0.5). FIG. 1 depicts the variance intensity module 108 as implementing a decay factor of 0.25. Thus, when the variance intensity module 108 updates the window 114A, the variance intensity module writes the values 150 ((1−0.25)×200) into time interval τ-4, 75 ((1−0.25)×100) into time interval τ-3, 0 into time interval τ-2, 375 ((1-0.25)×500) into time interval τ-1, and 0 into time interval τ, as illustrated by window 114B.

The particular decay factor can be a configurable value read from the configuration data. Additional variations are possible as well. To emphasize older rule breaches, the decay factor can be greater than one. Additionally, more complex techniques can be employed. For example, the decay factor can be applied to the time intervals of the window 114A if no rule is breached during the current time interval, but not be applied to the time intervals of the window 114A if a rule is breached during the current time interval. In some implementations, the decay factor increases in value for each consecutive time interval in which a rule is not breached.

As another example, a progressive decay factor may be used. A progressive decay factor increases as a particular weight ages. For example, the decay factor applied when writing a weight into time interval τ-4 might be 0.20; the decay factor applied when writing a weight into time interval τ-3 might be 0.15; the decay factor applied when writing a weight into time interval τ-2 might be 0.10; and the decay factor applied when writing a weight into time interval τ-1 might be 0.05. The weights thus decay faster as the weights age.

As described above, the implementation of the window 114A can vary. The operations performed to update the window 114A can thus vary accordingly. Additionally, the mechanism used to define a time interval can vary, and thus the particular timing of the operations depicted at stage F can vary. For example, the time intervals might be based off of received measurements. For example, the variance intensity module 108 can perform the operations at stage F each time a measurement is received (e.g., at stage A). In some implementations, the variance intensity module 108 can perform the operations at stage F after a set amount of time has passed. For example, the variance intensity module 108 might update the window 114A every fifteen seconds regardless of whether a new measurement has been received from the agent 102.

By modifying the threshold levels, the sensitivity to operational variances can be reduced. Consider a scenario in which the performance manager 104 monitors the latency of the application 100. Under normal operating conditions, the latency of the application 100 might be considered “steady state” inasmuch as the latency might vary within a particular range. The rule processor 106 might use the following four rules to detect operational variances:

1. When any single measurement is outside of three standard deviation from the average latency;

2. When two out of three consecutive measurements are outside of two standard deviations from the average latency;

3. When four out of five consecutive measurements are outside of one standard deviation from the average latency; and

4. When ten consecutive measurements are either increasing or decreasing.

The four rules can each be weighted according to how indicative of a potential issue they are. For example, a single measurement that falls outside of three standard deviations from the average latency might be highly indicative of an issue, and thus be given a weight of 500. Ten consecutive points that are all increasing, on the other hand, might rarely be indicative of an issue, and is thus given a weight of 100. Because the rule processor 106 selects the greatest weight of any breached rule, the first rule (weighted 500) would be given precedence over the fourth rule (weights 100).

If the application 100 receives an unusually high number of requests, the latency might spike as the application 100 is overwhelmed. The performance manager 104 might detect a high number of operational variances and thus output a high scaled variance intensity 116, causing an administrator to receive a large number of alerts. However, in some instances, the increased number of requests might be expected. For example, if the application 100 is a web server hosting information on a new product, the administrator might expect the traffic to briefly increase as user request information on the new product. The administrator may decide that no action needs to be taken since the increased traffic is temporary. Thus, to reduce the number of alerts received, the administrator might increase the threshold levels. When the threshold levels are increased, the variance intensity thresholds calculated at stage A increase. By increasing the threshold levels, a change in the variance intensity 112 results in a smaller change in the scaled variance intensity 116.

Other configurable options can be used to modify the variance intensity 112. For example, if the window size is increased, a breached rule will impact the variance intensity 112 for a longer period of time. In other words, the sum of the weights in the window 114A may include a larger number of breached rules, thus resulting in a larger variance intensity 112 that falls more slowly than if the window size were smaller. Similarly, a smaller decay factor will result increase the impact of older breached rules, thus resulting in a larger variance intensity 112. Additionally, the rules themselves might be configurable. For example, rule #4, above, might be configured to be triggered when six consecutive measurements, instead of ten consecutive measurements, are either increasing or decreasing.

Although the rule processor 106 is described as selecting the maximum weight of all breached rules for a particular time interval, implementations can vary. For example, when multiple rules are breached during a particular time interval, the rule processor 106 might select multiple weights and sum them together before associating them with the current time interval. As another example, the rule processor 106 might select the maximum weight of all breached rules for a particular time interval, but increase the weight based on the number of breached rules. The particular technique used to determine the value to associate with the current time interval can vary based on particular scenarios, applications, etc. For example, some types of operational variances might be more indicative of a particular problem when a combination of characteristics are detected (e.g., by multiple rules) than if a single rule is breached.

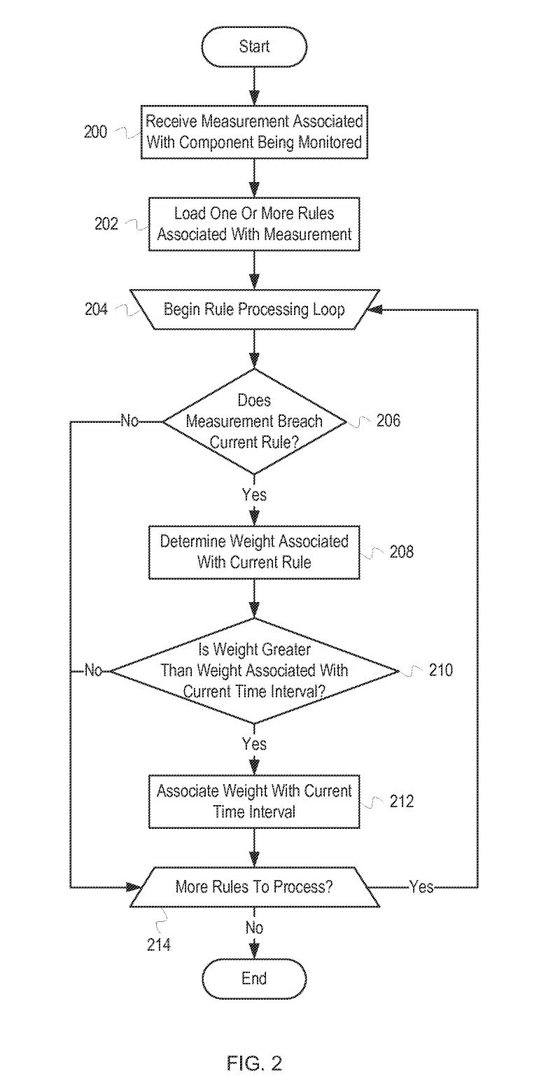

FIG. 2 depicts a flowchart of example operations for detecting an operational variance. The operations depicted in FIG. 2 can be performed by a rule processor, such as the rule processor 106 depicted in FIG. 1, or any suitable component.

To detect an operational variance, a rule processor receives a measurement associated with a component being monitored (200). The measurement can be received from the component itself, a module within the component, another component, etc. The measurement can be related to a performance metric, such as latency, memory usage, etc.

After receiving the measurement associated with the component, the rule processor loads one or more rules associated with the measurement (202). The rules can be loaded from configuration data located in a configuration file or another data source, such as a database. The rules can be selected from a larger set of rules based on various parameters. For example, some rules may be applicable to certain measurements or certain components.

After loading the rules, the rule processor begins a rule processing loop (204). During the rule processing loop, the rule processor determines whether the measurement results in a breached rule. Prior to beginning the rule processing loop, the rule processor identifies a first of the rules as the current rule. At the beginning of the loop during each subsequent iteration, the rule processor identifies an unprocessed rule as the current rule.

After identifying the current rule, the rule processor determines whether the measurement breaches the current rule (206). The particular operations performed to determine whether the measurement breaches the current rule can vary depending on the type of rule. For example, some rules may be threshold rules that are breached when the measurement meets one or more thresholds. As another example, some rules might be breached based, at least in part, on historical measurements. In such instances, the rule processor might analyze a history of measurements or track various characteristics of one or more past measurements.

If the measurement does breach the current rule, the rule processor determines a weight associated with the current rule (208). The weight associated with the current rule can be specified as part of the configuration data that includes the current rule. Thus, the weight associated with the current rule may be loaded from the configuration data when the current rule is loaded from the configuration data. In some instances, the weight can be zero, effectively “turning off” the current rule.

After the rule processor determines the weight associated with the current rule, the rule processor determines whether the weight is greater than a weight currently associated with the current time interval (210).

If the weight is greater than any weight currently associated with the current time interval, the rule processor associates the weight with the current time interval (212). The particular technique used to associate the weight with the current time interval can vary based on the particular implementation. For example, if the time intervals (e.g., the window) is implemented using an array, the rule processor can write the weight into the array element that corresponds to the current time interval. As another example, if the time intervals are implemented using a circular buffer, the rule processor can write the weight into a buffer element identified by a particular reference.

After the rule processor associated the weight with the current time interval, if the rule processor determined that the measurement did not breach the current rule (206) or if the rule processor determined that the weight is not greater than a weight associated with the current time interval (210), the rule processor determines whether there are any more rules to process (214).

If the rule processor determines that there are more rules to process, the rule processor performs another iteration of the rule processing loop (204).

If the rule processor determines that there are no more rules to process, the process ends.

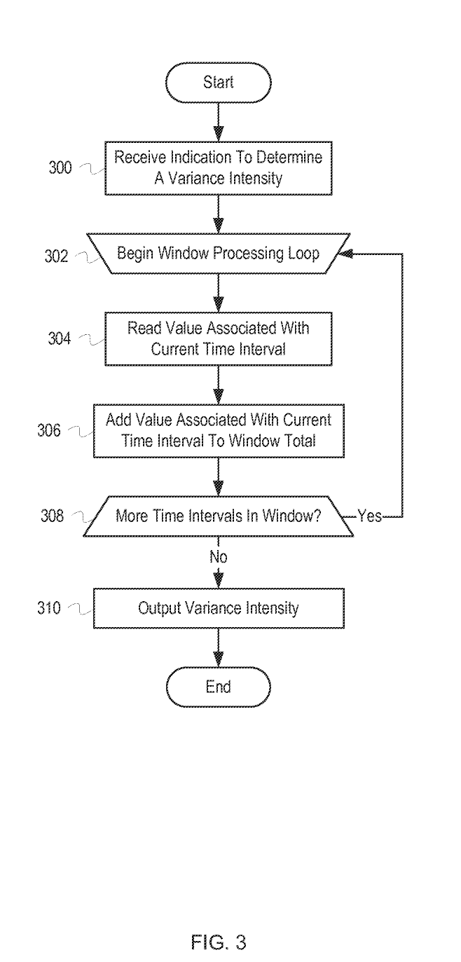

FIG. 3 depicts a flowchart of example operations for determining a variance intensity. The operations depicted in FIG. 3 can be performed by a variance intensity module, such as the variance intensity module 108 depicted in FIG. 1, or any suitable component.

To determine a variance intensity, a variance intensity module receives an indication to determine a variance intensity (300). The particular indication received by the variance intensity module can vary. For example, the variance intensity module might receive a notification from a rule processor indicating that an operational variance was found. As another example, the variance intensity module might receive a notification that a measurement was received or that a time interval has passed.

After receiving an indication that the variance intensity should be determined, the variance intensity module begins a window processing loop (302). During the window processing loop, the variance intensity module processes the time intervals that comprise the window and determines a window total. Prior to beginning the window processing loop, the variance intensity module identifies a first of the time intervals that comprise the window as the current time interval. Additionally, the variance intensity module initializes a “window total” variable. At the beginning of the loop during each subsequent iteration, the variance intensity module identifies an unprocessed time interval that comprises the window as the current time interval.

After identifying the current time interval, the variance intensity module reads a value associated with the current time interval (304). The particular mechanism used to read the value can vary based on the implementation of the window. For example, if the window is implemented as an array, the current time interval can be a reference to a particular element of the array. Thus, the variance intensity module can read the value from the element of the array referenced by the current time interval. If the window is implemented as a queue, the variance intensity module can “pop” the first element off of the queue.

After reading the value associated with the current time interval, the variance intensity module adds the value associated with the current time interval to the window total (306).

After adding the value associated with the current time interval to the window total, the variance intensity module determines whether there are any unprocessed time intervals in the window (308). If there are any unprocessed time intervals in the window, the variance intensity module begins a new iteration of the window processing loop (302).

If there are no unprocessed time intervals in the window, the variance intensity module outputs the variance intensity (310). To output the variance intensity, the variance intensity module can send the variance intensity as a message to another component, store the variance intensity to a particular location in memory, etc.

After the variance intensity module has output the variance intensity, the process ends.

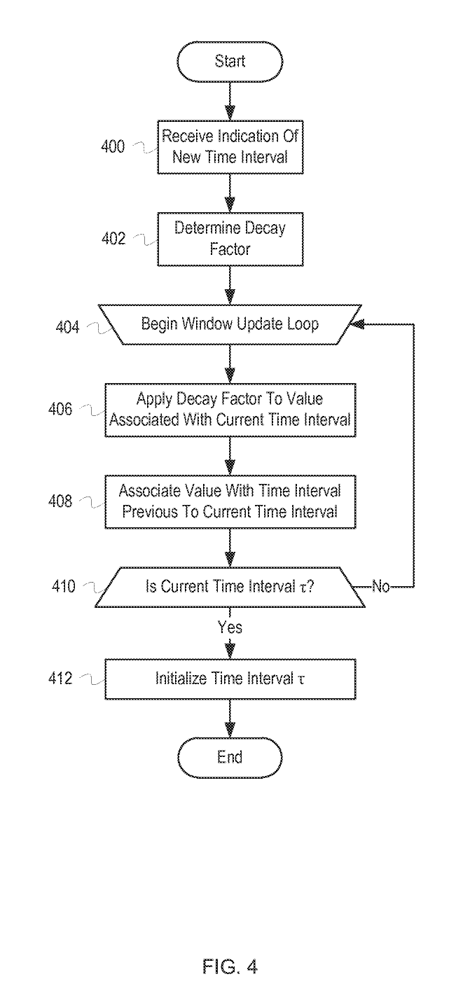

FIG. 4 depicts a flowchart of example operations for updating a window of time intervals. The operations depicted in FIG. 4 can be performed by a variance intensity module, such as the variance intensity module 108 depicted in FIG. 1, or any suitable component.

A variance intensity module first receives an indication of a new time interval (400). The indication of the new time interval can vary. For example, the indication of the new time interval can come from a timer that indicates that a particular amount of time has passed. The indication of the new time interval can be implicit. For example, the variance intensity module may receive an indication that a new measurement has been received and, based off of the reception of the indication that the new measurement has been received, determine that a new time interval has begun.

After receiving the indication of the new time interval, the variance intensity module determines a decay factor (402). The decay factor can be determined from configuration data located in a configuration file or another data source, such as a database. The decay factor can be any value but is typically a number between zero and one.

After determining the decay factor, the variance intensity module begins a window update loop (404). During the window update loop, the variance intensity module associates values with a previous time interval. Prior to beginning the first iteration of the window update loop, the variance intensity module identifies a second of the time intervals that comprise the window as a current time interval. The first of the time intervals is skipped because the first of the time intervals is the oldest time interval in the window. The oldest time interval is “dropped” from the window by being overwritten with the value in the second of the time intervals. At the beginning of each subsequent iteration through the window update loop, the variance intensity module identifies an unprocessed time interval that comprises the window as the current time interval. In this particular example, the window is implemented as an array. The variance intensity module iterates over the array elements based on the chronological order of the corresponding time intervals. In other words, the current time interval of the first iteration might be τ-5, the current time interval of the second iteration might be τ-4, etc.

After identifying the current time interval, the variance intensity module applies the decay factor to a value associated with the current time interval (406). Generally, the decay factor is applied to the value by multiplying the value by the decay factor. However, the particular implementation of the decay factor can vary. Thus, the technique used to apply the decay factor to the value can vary accordingly.

After applying the decay factor to the value, the variance intensity module associates the value with the time interval previous to the current time interval (408). Thus, for example, if the current time interval is τ-2, the variance intensity module associates the value with τ-3. The particular technique used to associate the value with the time interval previous to the current time interval can vary. For example, if the window is implemented using an array, the variance intensity module can read the value from the array element corresponding to the current time interval and write the value to the array element corresponding to the previous time interval.

After associating the value with the previous time interval, the variance intensity module determines whether the current time interval is τ (410). If the current time interval is not τ, the variance intensity module begins a new iteration of the window update loop (404).

If the current time interval is τ, the variance intensity module initializes time interval τ (412). The particular technique used to initialize time interval τ can vary. For example, if the window is implemented as an array, the variance intensity module might write a zero or null value into the array element corresponding to time interval τ. After the variance intensity module initializes time interval τ, the process ends.

The particular operations performed to update the window can vary according to the implementation of the window. For example, the operations depicted in FIG. 4 are directed to an implementation that uses an array to represent the window. If the window were implemented as a circular buffer, the variance intensity module can update the window by updating a reference to the head of the circular buffer. If the window were implemented as a queue, the window would be updated automatically by pushing a new value onto the queue (as might be done by a rule processor when a rule is breached). The variance intensity module would still perform operations to apply the decay factor.

In some implementations, the variance intensity module may not initialize time interval τ during the process of updating the window. Instead, a rule processor might be implemented to initialize time interval τ if no rule is breached during the time interval.

In some implementations, the decay factor is determined (402) within the window update loop (404). For example, if the decay factor may be different for each time interval (e.g., a progressive decay factor), the variance intensity module might determine the decay factor for the current time interval during each iteration instead of once for all time intervals.

FIG. 5 depicts a flowchart of example operations for determining variance intensity thresholds. The operations depicted in FIG. 5 can be performed by a threshold manager, such as the threshold manager 110 of FIG. 1, or any suitable component.

To determine variance intensity thresholds, a threshold manager determines a window size (500). The window size is the number of time intervals in the window. The window size can be determined from configuration data located in a configuration file or another data source, such as a database.

The threshold manager also determines the average of weights associated with rules used for detecting operational variances (502). The rules and/or the weights associated with each of the rules can be loaded from configuration data located in a configuration file or another data source, such as a database. The threshold manager determines the sum of all of the weights and divides the sum by the number of rules to determine the average of the weights.

The threshold manager also determines threshold levels and threshold level ranges (504). The threshold levels and threshold level ranges may be determined from configuration data located in a configuration file or another data source, such as a database. Each threshold level corresponds to a value in a respective threshold level range. For example, a first threshold level may correspond to a first threshold level range. If the first threshold level range includes values of one through seven, the first threshold value may be any value between one and seven, inclusive. Multiple threshold levels may share the same threshold level range. Additionally, each threshold level corresponds to a particular variance intensity threshold. For example, a first variance intensity threshold may correspond to a “caution” threshold and a second variance intensity threshold may correspond to a “danger” threshold.

After determining the window size, average weight, threshold levels, and threshold level ranges, the threshold manager begins a threshold processing loop (506). During the threshold processing loop, the threshold manager determines variance intensity thresholds based, at least in part, on the window size, average weight, threshold level and threshold level ranges for each of the threshold levels. Prior to the first iteration of the threshold processing loop, the threshold manager identifies a first of the threshold levels as the current threshold level. At the beginning of each subsequent iteration of the threshold processing loop, the threshold manager identifies a threshold level that has not been processed yet.

After identifying the current threshold level, the threshold manager determines a percentage assigned to the threshold corresponding to the current threshold level (“threshold percentage”) (508). The threshold percentage may be determined from configuration data located in a configuration file or another data source, such as a database. The threshold percentages corresponding to threshold levels determined at block 504 typically add up to be 100%. As described below, however, the threshold manager may adjust values related to the threshold percentage, causing the threshold percentages to add up to be greater than or less than 100%.

After determining the threshold percentage, the threshold manager determines a threshold level percentage (510). The threshold level percentage is the proportion of the threshold percentage allocated to each individual threshold level of the threshold level range. To determine the threshold level percentage, the threshold manager divides the threshold percentage by the number of threshold levels in the threshold level range corresponding to the current threshold level. For example, if the current threshold level corresponds to a threshold range comprising the values one through seven, the threshold manager would divide the threshold percentage by seven. The resulting value is the threshold level percentage. In some implementations, the threshold manager may adjust the threshold level percentage by rounding the threshold level percentage to the nearest whole number (or performing similar operations). For example, if the threshold percentage is 40% and the number of threshold levels is seven, the threshold level percentage is determined to be 5.71% (40%÷7). The threshold manager may round the threshold level percentage to the nearest whole number, or 6% in this case.

After determining the threshold level percentage, the threshold manager determines the variance intensity threshold based, at least in part, on the threshold level percentage, the window size, the current threshold level, and the average weight (512). In particular, the threshold manager multiplies the threshold level percentage, the window size, the current threshold level, and the average weight. The resulting value is the variance intensity threshold. The threshold manager may also take into account other variance intensity thresholds when calculating the variance intensity threshold. For example, if the variance intensity thresholds are sequential (e.g., the largest “caution” threshold is less than or equal to the smallest “danger” threshold), the threshold manager may base a second variance intensity threshold on the maximum value for the first variance intensity threshold, as discussed below.

After determining the variance intensity threshold, the threshold manager determines whether there are more threshold levels to process (514). If there are more threshold levels to process, the threshold manager begins another iteration of the threshold processing loop (506). If there are no more threshold levels to process, the process ends.

The operations depicted in FIG. 5 can be illustrated further using an example configuration. The threshold manager determines that the window size is 5 (500). The threshold manager determines that the rule weights are 500, 300, 200, and 100. Thus, the threshold manager determines that the average weight associated with the rules is 275 (502). The threshold manager determines that a first variance intensity threshold level is 1 and that the threshold range for the first variance intensity threshold comprises 1 through 5 (504). The threshold manager also determines a second threshold level is 4 and that the threshold range for the second variance intensity threshold comprises the values one through five, similar to the first variance intensity threshold (504).

During the first iteration through the threshold processing loop (506), the threshold manager determines that the threshold percentage for the first variance intensity threshold is 40% (508). The threshold manager also determines that the threshold level percentage is 8% (threshold percentage÷number of threshold values in threshold range; 40±5) (510). The threshold manager thus calculates the first variance intensity threshold as 110 (threshold level percentage×window size×first threshold level×average weight; 8%×5×1×275) (512). In this example, the first and second variance intensity thresholds are sequential, e.g. the second variance intensity threshold is calculated based on the maximum value of the first variance intensity threshold. Thus, the threshold manager also determines the maximum value of the first variance intensity threshold. In this example, the threshold manager calculates the maximum value of the first variance intensity threshold as 550 (threshold level percentage×window size×maximum first threshold level×average weight; 8%×5×5×275).

During the second iteration through the threshold processing loop (506), the threshold manager determines that the threshold percentage for the second variance intensity threshold is 60% (508). The threshold manager also determines that the threshold level percentage is 12% (threshold percentage÷number of threshold values in threshold range; 60÷5) (510). The threshold manager thus calculates the second variance intensity threshold as 1210 (maximum value of the first variance intensity threshold+(threshold level percentage×window size×second threshold level×average weight); 550+(12%×5×4×275)) (512).

In some implementations, the threshold levels for different variance intensity thresholds may overlap. For example, the highest caution level, 5, may be the same as the lowest danger level, 1. Such a configuration can allow the lower variance intensity threshold to be effectively turned off by setting the threshold level to the highest threshold level. Thus, if a user sets the caution threshold to 5 and the variance intensity is greater than the caution threshold, it also triggers the danger threshold, effectively overriding the caution threshold.

Additionally, there may be any number of variance intensity thresholds, and different variance intensity thresholds can be determined using different techniques. For example, the previous example might also include a third variance intensity threshold that is calculated as the maximum possible sum of weights in a window. The maximum possible sum of weights in a window generally occurs when all time intervals in a window contain the maximum possible weight. Thus, if the window size is five and the maximum rule weight is 500, the maximum possible sum of weights in the window occurs when all five time intervals as associated with a weight of 500, resulting in a sum of 2500.

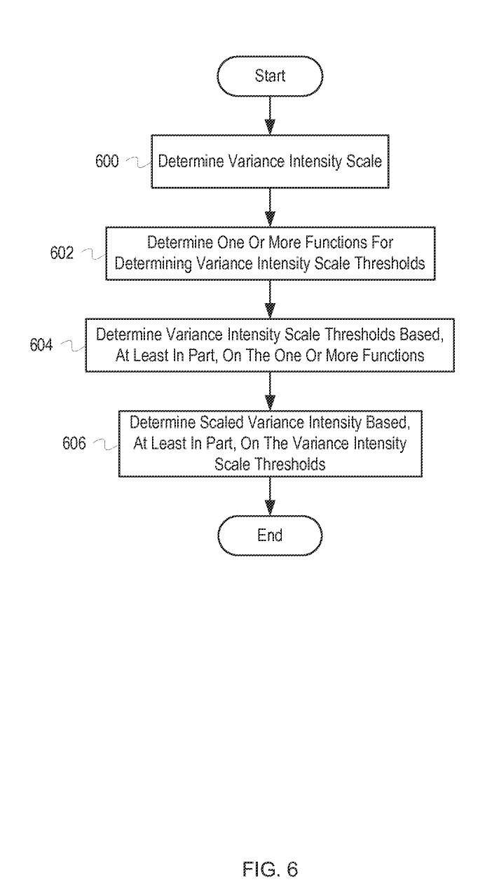

FIG. 6 depicts a flowchart of example operations for determining a scaled variance intensity based, at least in part, on one or more functions. The operations depicted in FIG. 6 can be performed by a threshold manager, such as the threshold manager 110 of FIG. 1, or any suitable component.

To determine a scaled variance intensity based, at least in part, on one or more functions, a threshold manager first determines a variance intensity scale and corresponding thresholds (600). The variance intensity scale can be loaded from configuration data located in a configuration file or another data source, such as a database.

The threshold manager also determines one or more functions for determining variance intensity scale thresholds (602). The functions can be loaded from configuration data located in a configuration file or another data source, such as a database.

After the functions for determining the variance intensity scale thresholds are determined, the threshold manager determines the variance intensity scale thresholds (604). The particular operations performed to determine the variance intensity scale thresholds using the functions can vary. For example, the variance intensity scale thresholds may be determined by iteratively evaluating a single function for each of the possible values in the variance intensity scale. As another example, the particular function evaluated might vary based on the position within the variance intensity scale. For example, Table 1 depicts an example set of functions for determining variance intensity scale thresholds associated with variance intensity scale comprising values 10 through 40. In Table 1, x is a first variance intensity threshold as calculated by the threshold manager by performing operations as depicted in FIG. 5, y is a second variance intensity threshold as calculated by the threshold manager by performing operations as depicted in FIG. 5, d is the difference between x and y (y−x), and n is the variance intensity scale value mod 10.

TABLE 1

| Variance Intensity Scale | Variance Intensity Scale Threshold |
|---|---|
| 10 | x ÷ 10 |
| 11-19 | x ÷ (10 − n) |
| 20 | x |
| 21-29 | x + d ÷ (10 − n) |
| 30 | y |
| 31-39 | y + (y + d)/(10 − n) |
| 40 | y + d |

The threshold manager thus evaluates each of the functions to determine the variance intensity scale threshold based on the previously calculated variance intensity thresholds and the variance intensity scale. For example, x is 1000, the variance intensity scale threshold for 15 is 200 (1000÷(10−5)) and the variance intensity scale threshold for 16 is 250 (1000÷(10−6)).

After the variance intensity scale thresholds have been determined, the threshold manager determines the scaled variance intensity based, at least in part, on the variance intensity scale thresholds (606). To determine the scaled variance intensity, the threshold manager compares the variance intensity to the variance intensity scale thresholds in ascending order. The scaled variance intensity is the value on the variance intensity scale corresponding to the first variance intensity scale threshold surpassed. Thus, if x is 1000 and the variance intensity is 240, the scaled variance intensity is 15.

Other techniques may be used to determine the scaled variance intensity. For example, the variance intensity scale may be associated with thresholds corresponding to variance intensity thresholds. For example, if the variance intensity thresholds include a caution threshold and a danger threshold, the variance intensity scale may also be associated with a caution threshold and a danger threshold. The scaled variance intensity can be determined by mapping the location of the variance intensity in relation to the variance intensity thresholds to variance intensity scale. For example, if the variance intensity is halfway between the caution threshold and the danger threshold, the scaled variance intensity would be the value on the variance intensity scale halfway between the associated caution and danger thresholds.

As another example, the scaled variance intensity may be determined by applying a scaling factor to the variance intensity. For example, if the maximum variance intensity is 4000 and the maximum value on the variance intensity scale is 40, the threshold manager might apply a scaling factor of 0.01 to the variance intensity. Thus, if the variance intensity is 2000, the scaled variance intensity would be 20. The threshold manager can determine the particular scaling factor to use by dividing the number of values in the variance intensity scale by the number of possible values for the variance intensity.

FIG. 1 is annotated with a series of letters, A through G. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 500, 502, and 504 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium does not include transitory, propagating signals.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

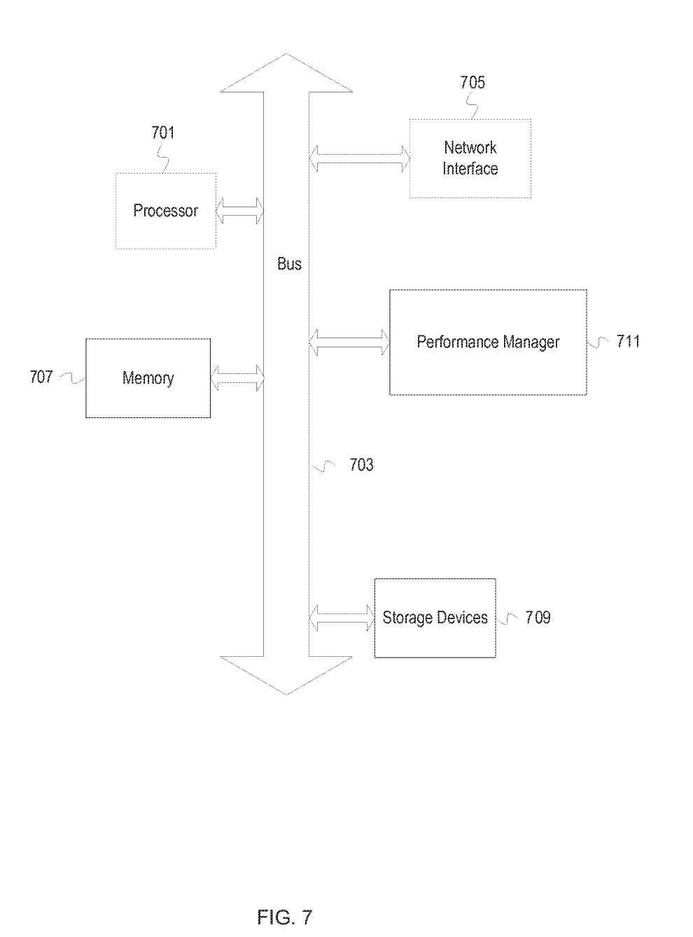

FIG. 7 depicts an example computer system with a performance manager. The computer system includes a processor 701 (possibly including multiple processors, multiple cores, multiple nodes, and/or implementing multi-threading, etc.). The computer system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 703 (e.g., PCI, ISA, PCI-Express, HyperTransport® bus, InfiniBand® bus, NuBus, etc.) and a network interface 705 (e.g., a Fiber Channel interface, an Ethernet interface, an internet small computer system interface, SONET interface, wireless interface, etc.). The system also includes a performance manager 711. The performance manager 711 embodies functionality to implement the operations described herein. In particular, the performance manager 711 embodies functionality to detect operational variances, determine variance intensities, update a window (possibly with a decaying factor), and determine variance intensity thresholds. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for determining variance intensities as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

What is claimed is:

1. A method comprising:
receiving a measurement associated with a component being monitored;
detecting an operational variance of the component based, at least in part, on the measurement;
determining a variance intensity associated with the operational variance; and
determining a first variance intensity threshold associated with the variance intensity.

2. The method of claim 1, wherein said detecting the operational variance of the component comprises determining that the measurement causes a first rule to be breached, wherein the method further comprises:
determining a first weight associated with the first rule; and
associating the first weight with a current time interval.

3. The method of claim 2, wherein said detecting the operational variance of the component further comprises determining that the measurement causes a second rule to be breached, wherein the method further comprises:
determining a second weight associated with the second rule; and
determining that the first weight is greater than the second weight;
wherein said associating the first weight with the current time interval is in response to said determining that the first weight is greater than the second weight.

4. The method of claim 2 further comprising:
after associating the first weight with the current time interval,
applying a decay factor to the first weight; and
associating the first weight with a previous time interval.

5. The method of claim 1, wherein said determining the variance intensity comprises determining the sum of a plurality of weights, wherein each of the plurality of weights is associated with one of a plurality of time intervals.

6. The method of claim 1, wherein the first variance intensity threshold is determined based, at least in part, on a window size, an average weight, and a threshold level.

7. The method of claim 1, wherein said determining the first variance intensity threshold comprises:
determining a first threshold percentage associated with the first variance intensity threshold;
determining a first threshold level percentage by dividing the first threshold percentage by a count of threshold levels in a first threshold level range, wherein the first threshold level range is associated with the first variance intensity threshold; and
determining the first variance intensity threshold based, at least in part, on the first threshold percentage.

8. The method of claim 7, wherein said determining the first variance intensity threshold based, at least in part, on the first threshold percentage comprises multiplying the first threshold level percentage, a window size, an average weight of weights associated with a plurality of rules, and a threshold level.

9. The method of claim 7 further comprising:
determining a second threshold percentage associated with a second variance intensity threshold;
determining a second threshold level percentage by dividing the second threshold percentage by a count of threshold levels in a second threshold level range, wherein the second threshold level range is associated with the second variance intensity threshold; and
determining the second variance intensity threshold based, at least in part, on the second threshold percentage.

10. The method of claim 1 further comprising determining a scaled variance intensity based, at least in part, on the variance intensity and a variance intensity scale.

11. The method of claim 10, wherein said determining the scaled variance intensity comprises:
determining variance intensity scale thresholds, wherein each of the variance intensity scale thresholds is associated with a value on the variance intensity scale; and
determining that the variance intensity is greater than a first of the variance intensity scale thresholds; and
determining the value on the variance intensity scale that is associated with the first of the variance intensity scale thresholds.

12. A machine readable storage medium having program code stored therein, the program code to:
receive a measurement associated with a component being monitored;
detect an operational variance of the component based, at least in part, on the measurement;
determine a variance intensity associated with the operational variance; and
determine a threshold associated with the variance intensity.

13. An apparatus comprising:
a processor; and
a machine readable medium having program code executable by the processor to cause the apparatus to,
receive a measurement associated with a component being monitored;
detect an operational variance of the component based, at least in part, on the measurement;
determine a variance intensity associated with the operational variance; and
determine a threshold associated with the variance intensity.

14. The apparatus of claim 13, wherein the program code executable by the processor to cause the apparatus to detect the operational variance of the component comprises program code executable by the processor to cause the apparatus to determine that the measurement causes a first rule to be breached, wherein the program code further comprises program code executable by the processor to cause the apparatus to:
determine a first weight associated with the first rule; and
associate the first weight with a current time interval.

15. The apparatus of claim 14, wherein the program code executable by the processor to cause the apparatus to detect the operational variance of the component further comprises program code executable by the processor to cause the apparatus to determine that the measurement causes a second rule to be breached, wherein the program code further comprises program code executable by the processor to cause the apparatus to:
determine a second weight associated with the second rule; and
determine that the first weight is greater than the second weight;
wherein the program code executable by the processor to cause the apparatus to associate the first weight with the current time interval comprises program code executable by the processor to cause the apparatus to associate the first weight with the current time interval in response to a determination that the first weight is greater than the second weight.

16. The apparatus of claim 14, wherein the program code further comprises program code executable by the processor to cause the apparatus to:
after associating the first weight with the current time interval,
apply a decay factor to the first weight; and
associate the first weight with a previous time interval.

17. The apparatus of claim 13, wherein the program code executable by the processor to cause the apparatus to determine the variance intensity comprises program code executable by the processor to cause the apparatus to determine the sum of a plurality of weights, wherein each of the plurality of weights is associated with one of a plurality of time intervals.

18. The apparatus of claim 13, wherein the threshold is determined based, at least in part, on a window size, an average weight, and a threshold level.

19. The apparatus of claim 13, wherein the program code executable by the processor to cause the apparatus to determine the threshold comprises program code executable by the processor to cause the apparatus to:
determine a threshold percentage associated with the threshold;
determine a threshold level percentage by dividing the threshold percentage by a count of threshold levels in a threshold level range, wherein the threshold level range is associated with the threshold; and
determine the threshold based, at least in part, on the threshold percentage.

20. The apparatus of claim 19, wherein the program code executable by the processor to cause the apparatus to determine the threshold based, at least in part, on the threshold percentage comprises program code executable by the processor to cause the apparatus to multiply the threshold level percentage, a window size, an average weight of weights associated with a plurality of rules, and a threshold level.
